(19) United States
(12) Patent Application Publication
(10) Pub. No.: US 2018/0169529 A1
(43) Pub. Date: Jun. 21, 2018

(54) SENSOR ACQUISITION AND ANALYTICS PLATFORM FOR ENHANCING INTERACTION WITH ADULT DEVICES

(71) Applicant: Standard Innovation Corporation, Ottawa (CA)

(72) Inventors: Bruce Donald MURISON, North Gower (CA); Frank Joseph FERRARI, Peterborough (CA); David Mitchell LOFSTROM, Ottawa (CA)

(73) Assignee: Standard Innovation Corporation, Ottawa, ON (CA)

(21) Appl. No.: 15/737,166

(22) PCT Filed: Jun. 16, 2016
(86) PCT No.: PCT/CA2016/050706

§ 371 Date: Dec. 15, 2017

Related U.S. Application Data
(60) Provisional application No. 62/180,128, filed on Jun. 16, 2015.
(60) Provisional application No. 62/192,637, filed on Jul. 15, 2015.

(51) Int. Cl. A63F 13/80; A63F 13/795; G06F 15/18; G06F 19/00; G06F 3/00; G06Q 30/02; G06Q 50/00; H04L 12/58

(52) U.S. Cl. CPC A63F 13/80; A63F 13/795; G06F 15/18; G06F 19/00; H04L 51/32; G06Q 30/02; G06Q 50/01; H04L 51/18; G06F 3/00

(57) ABSTRACT

A sensor acquisition and analytics platform for enhancing interaction with adult devices. More specifically, the integration of social networking and gamification (i.e., adding game-like features to the interactions between adult devices and the user(s)) frameworks towards enhancing user interactions and joint activities surrounding adult devices, services, and/or content is introduced. Additionally, analytics and learning intelligence (in the form of adaptive learning or behavioral pattern prediction) may be implemented (either as part of the framework or separately), which serves to discover appropriate connections, mappings, or associations between adult device characteristics/settings and measured sensor information (including user biometrics, forces, pressure, motion, etc.). These connections, in turn, may be further examined and improved over time by the platform and/or third-party providers to develop and/or improve user experiences with respect to health, wellness, and/or sexual activities involving adult devices.

### BACKGROUND

To date, the ability to extend wireless interfaces and adult device configurability has yet to be extensively pursued despite developments to technologies such as social media, wearable devices, cloud storage, online purchasing, local and wide area networking, etc. These technologies are capable of enhancing interaction with adult devices but require a sensor acquisition and analytics platform for supporting the socialization and gamification of adult devices.

### SUMMARY

In general, in one aspect, the invention relates to a system. The system includes a data repository, and a platform kernel communicatively connected to the data repository, the platform kernel configured to execute instructions on a computer processor to perform receiving a message from a client device, the message comprising a plurality of interaction information, examining the message to identify a context, determining whether the context requires at least one platform specific utility (PSU), sending the plurality of interaction information to the at least one PSU, and obtaining output from the at least one PSU in the form of a plurality of connections between the plurality of interaction information and an adult device.

In general, in one aspect, the invention relates to an adult device. The adult device includes a sensor configured to obtain a plurality of input data, a computer processor receiving the plurality of input data from the sensor and configured to execute instructions to pre-process the plurality of input data in a format accepted by a client device to obtain processed data, send the processed data to the client device, and receive, from the client device, device specific instructions (DSI) to modify operations of the adult device, and a power source configured to provide power to the computer processor and the sensor.

In general, in one aspect, the invention relates to a method for enhancing interactions with an adult device. The method includes receiving a message from a client device, the message comprising interaction information, examining the message to identify a context, determining whether the context requires at least one platform specific utility (PSU), sending the interaction information to the at least one PSU, and obtaining output from the at least one PSU in the form of a plurality of connections between the interaction information and the adult device.

In general, in one aspect, the invention relates to a method for controlling an adult device. The method includes receiving an action from an adult device platform (ADP), processing the action to obtain device specific instructions (DSI), identifying, based on the action, the adult device to which the DSI is designated, and transmitting the DSI to modify operations of the adult device.

Other aspects of the invention will be apparent from the following description and the appended claims.

### BRIEF DESCRIPTION OF DRAWINGS

FIG. 1 shows a flow diagram of a system in accordance with one or more embodiments of the invention.

FIG. 2 shows a diagram of an adult device platform (ADP) in accordance with one or more embodiments of the invention.

FIG. 3 shows a diagram of an adult device and/or wearable device in accordance with one or more embodiments of the invention.

FIG. 4 shows a diagram of a client device in accordance with one or more embodiments of the invention.

FIG. 5 shows a diagram of a platform software development kit (SDK) in accordance with one or more embodiments of the invention.

FIG. 6 shows a flowchart that describes a method for generating device specific instructions (DSI) in accordance with one or more embodiments of the invention.

FIG. 7 shows a flowchart that describes a method for generating an action in accordance with one or more embodiments of the invention.

FIG. 8.1 and FIG. 8.2 each show a diagram of a computing system in accordance with one or more embodiments of the invention.

FIG. 9 shows a flow diagram of an example in accordance with one or more embodiments of the invention.

### DETAILED DESCRIPTION

Specific embodiments of the invention will now be described in detail with reference to the accompanying figures. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In the following description, any component description with regard to a figure, in various embodiments of the invention, may be equivalent to one or more like-named components described with regard to any other figure. For brevity, descriptions of these components will not be repeated with regard to each figure. Thus each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to a sensor acquisition and analytics platform for enhancing interaction with adult devices. More specifically, one or more embodiments of the invention integrate social networking and gamification (i.e., adding game-like features to the interactions between adult devices and the user(s)) frameworks towards enhancing user interactions and joint activities surrounding adult devices, services, and/or content. Additionally, analytics and learning intelligence (in the form of adaptive learning or behavioral pattern prediction) may be implemented (either as part of the framework or separately), which serves to discover appropriate connections, mappings, or associations between adult device characteristics/settings and measured sensor information (including user biometrics, forces, pressure, motion, etc.). These connections, in turn, may be further examined and improved over time by the platform and/or third-party providers to develop and/or improve user experiences with respect to health, wellness, and/or sexual activities involving adult devices.

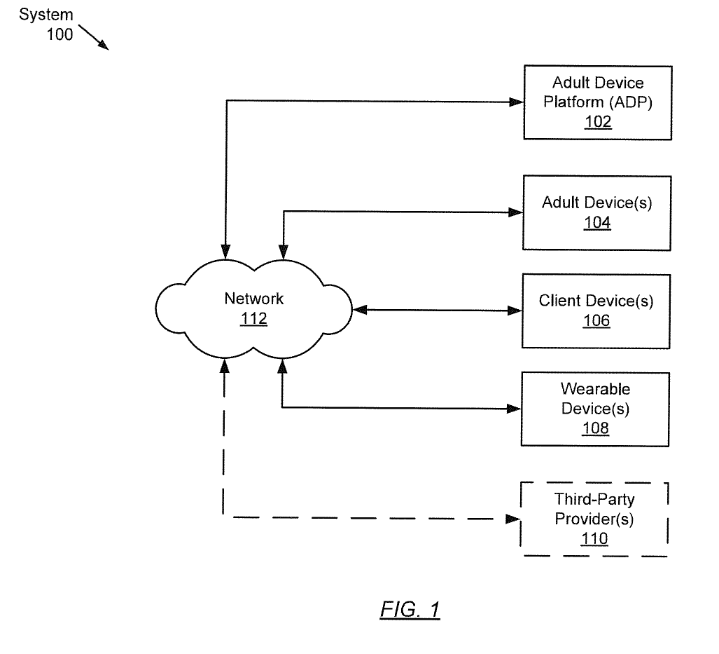

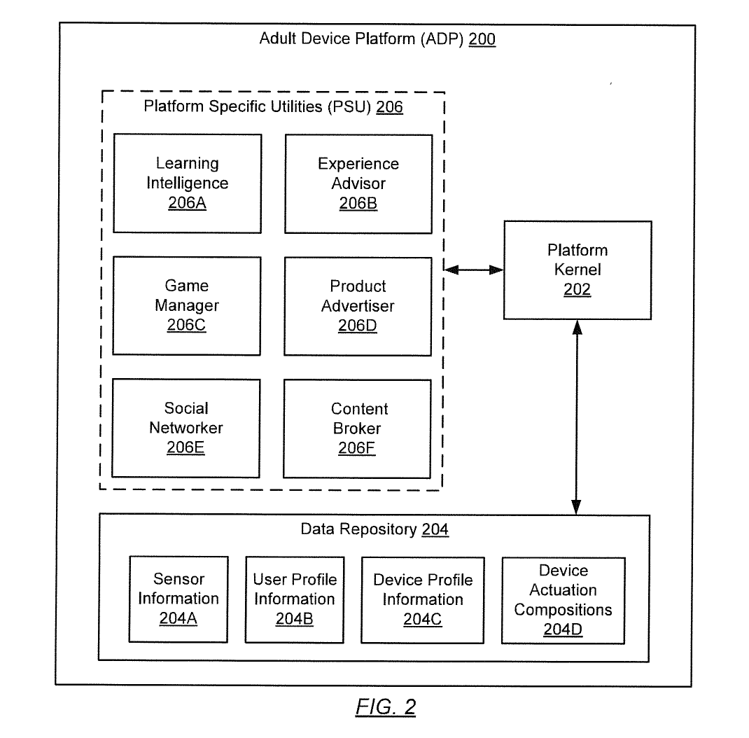

In one or more embodiments of the invention, the platform (see, e.g., the adult device platform shown in FIG. 1 and FIG. 2) for enhancing interaction with adult devices allows for various payment models for its owner. Certain payment models involve payment by the actual user(s) of the adult device, while other payment models involve payment by individuals or entities other than the user(s) (such as a start-up business, an established business without such a platform, the user's companion, a party attendee, etc.).

Payments by the user(s) of the adult device may include a recurring subscription fee, a one-time lump sum or per use charge for one or more specific behavioral pattern(s), access to gamification features, or other features or offerings made available by the platform (see, e.g., the adult device platform shown in FIG. 1 and FIG. 2). Such payments may be manifested as an increase in the original purchase price of the device or as an additional feature/add-on service in addition to the original purchase price (and/or at a different time than the original purchase of the adult device).

Payments by individuals or entities other than the user(s) of the adult device may include a recurring subscription fee or a one-time lump sum to have access to services (including, but not limited to, features or offerings) made available by the platform (see, e.g., the adult device platform shown in FIG. 1 and FIG. 2). In such a payment model, the services would be made available to individuals or entities other than the user(s) of the adult device on an as-needed basis for a reasonable fee as compared to developing an entire platform itself or purchasing more than needed (similar to software-as-a-service (SaaS) topology). In one or more embodiments of the invention, the payments to the owner of the platform would grant access to the entire functionality and services of the platform or only a limited portion of the platform (that could increase or decrease, as desired). For example, a start-up company would be able to offer gamification and behavioral patterns (leveraging the platform described herein) with the launch of its newly designed adult device to ensure a positive user experience and successful launch that would otherwise not be possible with the limited funding/budget resources available to start-up companies. As another example, a companion of an adult device user does not own an adult device or has not purchased or subscribed to features offered by the platform. Therefore, the companion is not able to enjoy the full experience of the adult device while interacting with his/her companion. By purchasing access to the network on an as-needed basis, the companion is able to fully enjoy the experience with the user of the adult device without being forced to purchase more than what the companion needed.

FIG. 1 shows a flow diagram of a system in accordance with one or more embodiments of the invention. The system (100) includes an adult device platform (ADP) (102), one or more adult devices (104), one or more client devices (106), one or more wearable devices (108), and optional third-party provider(s) (110). Further, in accordance with one or more embodiments of the invention, one or more of these components are operatively connected to one another or each other via a network (112). Each of these components is described below. One of ordinary skill in the art will appreciate that the invention is not limited to the system shown in FIG. 1.

In one embodiment of the invention, the ADP (102) refers to hardware, software, firmware, or any combination thereof, which provides support resources for a respective software application (see, e.g., FIG. 4), device(s), application programming interface (API), software tool, set of software tool(s), etc. These support resources may include, for example, cloud computing logic, data storage, content generation, access, and/or dissemination, software and/or firmware updates, platform specific utilities (PSU) (see, e.g., FIG. 2), and device specific instructions (DSI) (discussed below).

As such, in one embodiment of the invention, the ADP (102) includes functionality to: (i) receive resource requests from one or more client devices (106); (ii) provide resources to the one or more client devices (106) in response to requests and/or other operations performed on a respective software application; and/or (iii) broker third-party products and/or services between platform users, device actuation composition (DAC) developers, and the third-party providers (110). The ADP (102) is further discussed below with respect to FIG. 2.

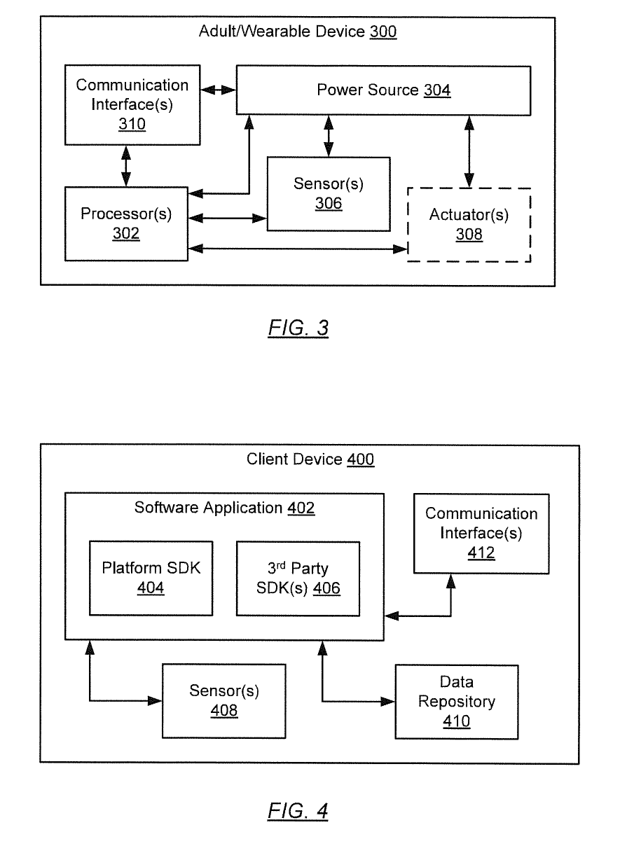

In one embodiment of the invention, adult device(s) (104) refer to a sexual pleasure, wellness, and/or exercise device, which may provide various functions when employed by one or more users. Adult device(s) (104) may include functionality to: (i) provide stimulus to one or more users; (ii) provide sensor information (from one or more sensors included in the adult device) to client device(s) (106); (iii) receive DSI and software/firmware updates from client device(s) (106); and (iv) obtain manual enablement and setting adjustments (for features associated with the adult device (104)), which may be performed by one or more users operating the adult device(s) (104). In one embodiment of the invention, the stimulus provided by an adult device (104) may include, but is not limited to, mechanical, piezoelectric, electro-mechanical, and electrical actuation, which may be penetrative or non-penetrative, and/or vibratory or non-vibratory. Examples of adult device(s) (104) include, but are not limited to, a dildo, a vibrator, a rabbit (i.e., two vibrators fused together, where one may be phallus-like shaped intended for insertion, while the other may be a smaller clitoral stimulator), a cock ring, a nipple stimulator, and a Kegel ball. Adult device(s) (104) are further discussed in with respect to FIG. 3.

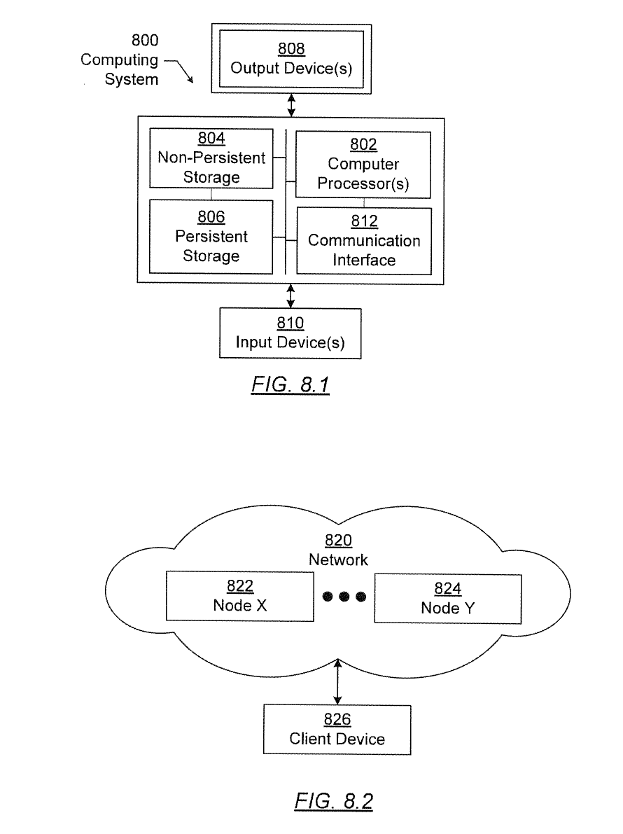

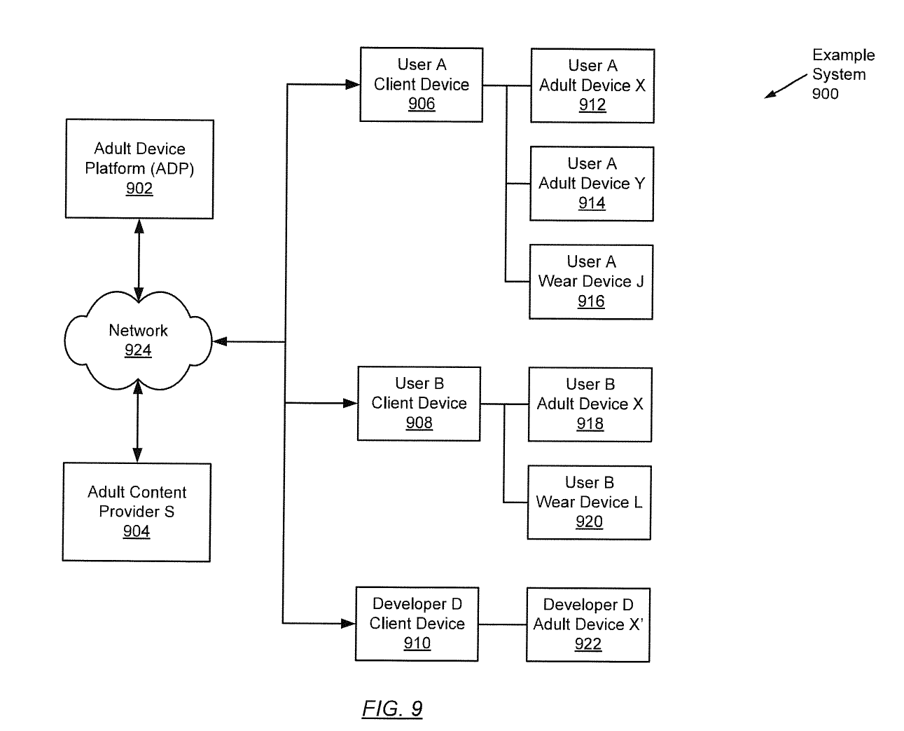

In one embodiment of the invention, client device(s) (106) are any computing system (see, e.g., FIGS. 8.1 and 8.2) that is programmed to interact with the ADP (102), adult device(s) (104), and/or wearable device(s) (108). Client device(s) (106) may include functionality to: (i) aggregate sensor information and setting adjustments from adult device(s) (104); (ii) generate and transmit resource requests to the ADP (102); (iii) receive resources from the ADP (102); (iv) obtain and/or record enablement and setting adjustments (for features associated with the software application (see, e.g., FIG. 4)), which may be performed by one or more users or DAC developers that may be operating the client device(s) (106); (v) present information (e.g., notifications, analytics, recommendations, content, etc.) to one or more users; and (vi) transmit device specific instructions (DSI) to the adult device(s) (104) and wearable device(s) (108), which may be operatively connected to the client device(s) (106). Examples of client device(s) (106) include, but are not limited to, a cellular telephone, a smartphone, a personal digital assistant (PDA), a gaming console, a laptop computer, a desktop computer, a computer server, an Internet-enabled appliance, a smart television, a tablet computer, an electronic reader, etc. Client device(s) (106) are further discussed below with respect to FIG. 3.

In one embodiment of the invention, wearable device(s) (108) are any computing system (see, e.g., FIG. 8.1 or FIG. 8.2), which may be worn by a user. Wearable device(s) may be embedded under, within, with or on top of clothing and/or accessories. Further, in one embodiment of the invention, wearable device(s) (108) include functionality to: (i) provide sensor information (from one or more sensors included in the wearable device) to client device(s) (106); and (ii) receive DSI from client device(s) (106). In one embodiment of the invention, wearable device(s) (108) may also function as adult device(s) (104). Examples of wearable device(s) (108) include, but are not limited to, a smart watch, e-textiles, a smart shirt, an activity tracker, smart glasses, etc. Wearable device(s) (108) are further discussed with respect to FIG. 3.

In one embodiment of the invention, third-party provider(s) (110) refer to an external platform for products, services, and/or content. Third-party provider(s) (110) may include functionality to: (i) provide their respective products, services, and/or content through the ADP (102) to registered users of the ADP; (ii) receive requests, from the ADP on behalf of a registered user, to access, obtain, or otherwise purchase their respective products, services, and/or content; and (iii) potentially, receive feedback, analytics, and/or recommendations for improvement regarding their products, services, and/or content directly from registered users of the ADP or from one or more of the platform specific utilities (PSU) (discussed below). Examples of third-party provider(s) (110) include, but are not limited to, a social network (e.g., Facebook, Instagram, Snapchat, LinkedIn, etc.), an adult device supplier (e.g., We-Vibe, Natural Contours, Lelo, etc.), an online retailer (e.g., Amazon, E-bay, etc.), an online personals website (e.g., PinkCupid, etc.), an online chat room and/or forum (e.g., Reddit, etc.), an adult multimedia content website (e.g., RedTube, etc.), and a multimedia content website (e.g., iTunes, etc.).

In one embodiment of the invention, the network (112) refers to the medium through which the ADP (102), the adult device(s) (104), the client device(s) (106), the wearable device(s) (108), and the third-party provider(s) (110) are operatively connected. The connections between these various components may be wired and/or wireless, direct or indirect, temporary, permanent and/or intermittent, through a local area or wide area network, or have any other type of connection or combination thereof. Further, the network (112) may include any existing or future developed systems and may employ any existing or future developed wired and/or wireless protocol, directed to the facilitation of communications and the exchange of information between the various components of the system (100).

FIG. 2 shows an adult device platform (ADP) in accordance with one or more embodiments of the invention. The ADP (200) includes a platform kernel (202), a data repository (204), and a set of PSU (206). Each of these components is described below. One of ordinary skill in the art will appreciate that the invention is not limited to the system shown in FIG. 2.

In one or more embodiments of the invention, the platform kernel (202) refers to hardware, software, firmware, or any combination thereof, which manages the operations of the ADP (200). The platform kernel (202) may include functionality to: (i) delegate tasks to the PSU (206) based on resource requests received by the ADP (200); (ii) allocate and/or prioritize system resources amongst the PSU (206); (iii) mediate inter-PSU communications and/or information exchange; and (iv) store and retrieve information to/from the data repository (204). The platform kernel (202) may perform additional and/or alternative functionalities without departing from the scope of the invention. Examples of a platform kernel (202) include, but are not limited to, one or more processors containing integrated circuitry and/or an operating system (representative of computer readable program code) executing on the one or more processors.

In one embodiment of the invention, the platform kernel (202) is operatively connected to a data repository (204). The data repository (204) may be any type of storage unit, data structure, and/or device (e.g., file system, database, collection of tables, or any other storage mechanism) for storing and/or consolidating information pertinent to embodiments of the invention. Further, the data repository (204) may be representative of multiple storage units, data structures, and/or devices, which may or may not be of the same type and/or located at the same physical site. In one embodiment of the invention, the information that may be stored/consolidated in the data repository may include, but is not limited to: (i) sensor information (204A) from sensors included in one or more adult devices, client devices, and/or wearable devices; (ii) current and/or historical profile information, settings, and/or preferences associated with a user (204B), a device (204C), and/or a DAC (discussed below) (204D); (iii) any content, data structures, and/or outputs generated and/or utilized by the PSU (206); and (iv) any runtime requirements (e.g., libraries, scripts, etc.) needed by the ADP (200) to fulfill one or more embodiments of the invention. In one embodiment of the invention, above-listed information (i)-(iii) may be collectively, or in various groupings, known as interaction information.

In one or more embodiments of the invention, the platform kernel (202) is further operatively connected to a set of PSU (206). In one embodiment of the invention, a PSU (206) refers to hardware, software, firmware, or any combination thereof, which implements one or more services, features, and/or functions provided by the ADP (200). The utilities that form the set of PSU (206) may include, but are not limited to, a learning intelligence (206A), an experience advisor (206B), a game manager (206C), a product advertiser (206D), a social networker (206E), and a content broker (206F). Each of these PSU is described below.

In one embodiment of the invention, the learning intelligence (206A) refers to hardware, software, firmware, or any combination thereof, which renders the ADP (200) analytic, adaptive learning, and behavioral prediction capabilities. Inputs for the learning intelligence (206A) may include, but are not limited to, recent and/or historical sensor information deriving from one or more client devices and/or users, and current and/or historical profile information (e.g., user, device, social networking, etc.) and preferences corresponding to one or more users. In brief, the learning intelligence (206A) may include functionality to: (i) apply one or more predetermined algorithms onto its inputs (mentioned above); (ii) determine, in response to (i), mappings or associations between its various inputs (e.g., between adult device characteristics and sensor information/user biometrics); and (iii) provide these mappings to the platform kernel (202) for storage, dissemination to one or more other PSU (206), and/or deliverance to one or more client devices and/or third-party providers.

In one embodiment of the invention, the learning intelligence (206A) may be implemented using, for example, neural network processing and/or any other machine learning paradigm, or any combination thereof. Additionally, or alternatively, the learning intelligence (206A) may employ one or more data mining, image processing, pattern recognizing, etc., techniques. Further, in one embodiment of the invention, these aforementioned mappings may enable the ADP (200) to learn, discover, and/or predict user habits/behavior, preferences, and triggers pertaining to sexual health, wellness, and enjoyment/entertainment.

More specifically, the learning intelligence (206A) may analyze similarities between a user's historical interaction information and the current and/or historical interaction information associated with other registered users of the ADP. In one embodiment of the invention, these other registered users may share affinities (e.g., pertaining to demographics, preferences, devices utilized, social connections, etc.) with the particular user associated with the habits and/or behaviors that are being observed and patterned. In one embodiment of the invention, the learning intelligence may utilize the resulting analytical observations to build and adaptively maintain a predictive model directed towards anticipating the user's forthcoming needs. The model may involve a feedback loop mechanism to allow for predictive learning. For example, for a particular user, historical interaction information (pertaining to the user and/or a population of affinity-sharing users) may be mined to create one or more predictive profiles for determining where within an orgasmic process the user is currently. Continuing with the example, based at least on the generated predictive profile(s), the learning intelligence (206A) may then adjust stimulation, provided by the adult device(s) interacting with the user, to coincide with the user's objectives (e.g., speed to which an orgasm is achieved, frequency of orgasms within a session, etc.) and other items learned over time for the particular user or the user's partner.

In one embodiment of the invention, the experience advisor (206B) refers to hardware, software, firmware, or any combination thereof, which renders the ADP (200) a recommendation service. Inputs of the experience advisor (206B) include, but are not limited to the mappings determined by the learning intelligence (206A) for one or more users and current and/or historical profile (e.g., user, device, social network, etc.) information consolidated in the data repository (204). As such, the experience advisor (206B) may include functionality to: (i) ascertain similarities between users, adult devices, and activities based on and/or using its inputs (mentioned above); (ii) provide, based on (i), users with recommendations to befriend like-minded users through the social networker (206E), the game manager (206C), and/or one or more third-party providers (not shown); and (iii) expose users to similarly preferred DAC (discussed below) developed by other like-minded users or the ADP (200).

In one embodiment of the invention, the game manager (206C) refers to hardware, software, firmware, or any combination thereof, which renders the ADP (200) gamification capabilities. In one or more embodiments of the invention, gamification refers to the application of typical game playing elements (e.g., achievements, scoring, competition, rewards, rules of play, etc.) to other, non-gaming areas of activity. Further, the objective of gamification is to encourage the retention and engagement of users directed to a particular product and/or service.

Inputs of the game manager (206C) include, but are not limited to recent and/or historical sensor information from one or more client devices associated with one or more users, state information describing the current and/or historical states of one or more adult devices and/or wearable devices, output(s) from one or more of the other PSU (206) (e.g., the social networker (206E), the content broker (206F), etc.), and any other information consolidated in the data repository (204) that may be pertinent to the functionality of the game manager (206C). Subsequently, the game manager (206C) may include functionality to: (i) generate and maintain game playing elements directed to one-player and/or multi-player activities involving adult devices; (ii) track the progress of one or more users participating in one or more games; and (iii) interface with other PSU (206) (e.g., the social networker (206E), the learning intelligence (206A), the content broker (206F), etc.) towards identifying and providing improvements to the gamification process.

In one embodiment of the invention, the product advertiser (206D) refers to hardware, software, firmware, or any combination thereof, which renders the ADP (200) advertising capabilities. Inputs of the product advertiser (206D) include, but are not limited to, the mappings/connections determined by the learning intelligence (206A) (discussed above), and current and/or historical profile (e.g., user, device, social networking, etc.) information pertaining to a particular user and/or similar users. As such, the product advertiser (206D) may include functionality to: (i) ascertain adult devices that may be liked, but not yet owned/utilized, by a particular user or set of users; (ii) achieve (i) by comparing information (e.g., adult device characteristics, user preferences, etc.) consolidated by the ADP (200) with publicly-available information surrounding one or more adult devices; (iii) interface, through the platform kernel (202), with third-party providers to provide exposure of their products, services, and/or content to users and DAC developers of the ADP (200); and (iv) generate, modify, and disseminate appropriate advertisements and/or promotions to appropriate users.

In one or more embodiment of the invention, the social networker (206E) refers to hardware, software, firmware, or any combination thereof, which renders the ADP (200) socialization capabilities. In one or more embodiments of the invention, socialization refers to the enablement of social networks or social relations amongst users who may, for example, share interests, activities, backgrounds, real-life connections, etc. Inputs of the social networker (206E) include, but are not limited to, mappings determined by the learning intelligence (206A) and output(s) from other PSU (206) (e.g., the game manager (206C), etc.), and any other current and/or recent information consolidated in the data repository (204). In one embodiment of the invention, the social networker (206E) may include functionality to: (i) ascertain and introduce like-minded users to one another; (ii) recommend ADP (200) and/or third-party provider (not shown) supported activities/services to a particular user or a set of users; and (iii) maintain the ADP (200) socialization process.

In one embodiment of the invention, the content broker (206F) refers to hardware, software, firmware, or any combination thereof, which renders the ADP (200) brokering capabilities. In one embodiment of the invention, the content broker (206F) may be representative of a marketplace for ADP (200) and/or third-party provider products, services, and/or content. A marketplace may be a virtual network space, supported by hardware and software, which connects ADP users (or consumers) to devices, services, and content that may be downloaded, shared, purchased, rented, etc. The marketplace may be a public or private market that is accessible via the Internet.

One of ordinary skill in the art will appreciate that the ADP (200) may include additional components (e.g., memory, additional and/or alternative PSU, interfaces, etc.) (not shown) without departing from the scope of the invention.

FIG. 3 shows a diagram of an adult and/or wearable device in accordance with one or more embodiments of the invention. The adult and/or wearable device (300) includes one or more processor(s) (302), a power source (304), one or more sensor(s) (306), optional actuator(s) (308), and one or more communication interface(s) (310). Each of these components is described below.

In one embodiment of the invention, processor(s) (302) are representative of one or more integrated circuits or other circuitry to allow operations, commands, or lines of code to be performed. The processor(s) (302) may include functionality to: (i) interpret and/or pre-process raw sensor data from the sensor(s) (306), thereby obtaining sensor information; (ii) control and/or drive the actuator(s) (308), if any; (iii) transmit the aforementioned sensor information to a client device (not shown); (iv) receive DSI from a client device (not shown); and (v) allocate local resources amongst the hardware, software, firmware, or any combination thereof components pertaining to the adult and/or wearable device (300). One of ordinary skill in the art will appreciate that the processor(s) (302) may perform additional responsibilities without departing from the scope of the invention. Examples of processor(s) (302) include, but are not limited to, a discrete processor, a digital signal processor (DSP), an application specific integrated circuit (ASIC), a microcontroller, a graphical processing unit (GPU), a field programmable gate array (FPGA), and any combination thereof.

In one embodiment of the invention, one or more components of an adult and/or wearable device (300) are operatively connected to a power source (304). The power source (304) may be any direct current (DC) power source used to power any and/or all of the various components of the adult and/or wearable device (300). In one embodiment of the invention, the power source (304) may be capable of distributing an appropriate amount of power to each component to which it is operatively connected. In one embodiment of the invention, the power source (304) may be a device, such as a battery, which is capable of being recharged. In such an embodiment, the power source (304) may include a management system (not shown) programmed to oversee the charging and discharging of power to/from the power source, monitor the current and/or historical state (e.g., temperature, pressure, leakage, energy, etc.) associated with the power source (304), etc. Further, the power source (304) may receive power from an external source.

In one embodiment of the invention, the processor(s) (302) are operatively connected to sensor(s) (306). Sensor(s) refer to hardware, software, firmware, or any combination thereof, which detects and measures one or more physical properties (e.g., heat, light, sound, pressure, motion, etc.). Sensor(s) (306) may further include functionality to encode these aforementioned measurements into analog and/or digital signals (or data) that may be interpreted and/or pre-processed by the processor(s) (302). Examples of sensor(s) (306) include, but are not limited to, an accelerometer, a global positioning system (GPS) device, a pressure sensor, a temperature sensor, a microphone, a camera, a light detector, a photopletismograph (PPG) (i.e., blood flow sensor), an electroencephalograph (EEG) (i.e., bioelectricity sensor), a photoionization detector (PID) (i.e., a gas and/or organic compound sensor), etc. In one embodiment of the invention, the one or more sensor(s) (306) serve, separately or in combination, to provide information pertaining to, for example, orientation, biometrics, environmental conditions, and control feedback (e.g., pertinent to the performance of the actuator(s) (308), if any).

In one embodiment of the invention, the processor(s) (302) may be operatively connected to actuator(s) (308). Actuator(s) (308) may be an electrical, piezoelectric, electro-mechanical, mechanical, or hydraulic device, or any combination thereof, which generates stimuli. In one embodiment of the invention, the nature of the stimuli may be kinetic, sensory, thermal, chemical, auditory, visual, and/or any other type of stimulus. Examples of actuator(s) (308) include, but are not limited to, a motor, an electric prodder, a fluidic pump, a piezoelectric element, a speaker, and an odorizer.

In one embodiment of the invention, the communication interface(s) (310) are operatively connected to the processor(s) (302). A communication interface (310) may be hardware, software, firmware, or any combination thereof, which enables and facilitates the exchange of information through a network, and subsequently, to/from other (remote) interfaces. In one embodiment of the invention, the communication interface(s) (310) includes functionality to: (i) receive sensor and/or state information from the processor(s) (302); (ii) transmit the information of (i) to remote communication interfaces associated with remote devices (e.g., a client device, etc.) through a network (see, e.g., 112 in FIG. 1); (iii) receive DSI from remote communication interfaces associated with remote devices; and (iv) provide the information of (iii) to the processor(s) (302). Examples of the communication interface(s) (310) include, but are not limited to, a computer port, a network interface controller, a network interface device, a network socket, and antennae.

FIG. 4 shows a client device in accordance with one or more embodiments of the invention. The client device (400) includes a software application (402) operatively connected to one or more sensors (408), a data repository (410), and one or more communication interfaces (412). Each of these components is described below.

In one embodiment of the invention, the software application (402) refers to any computer program product that enables an operator (e.g., user or DAC developer) of a client device (400) to exercise embodiments of the invention. The software application (402) may include different versions, modules, components, and/or editions of the same software application. In one or more embodiments of the invention, the software application (402) may include functionality to enable operators to: (i) remotely establish and/or modify features and/or settings associated with one or more adult and/or wearable device(s); (ii) toggle and/or adjust features and/or settings (e.g., socialization, gamification, etc.) associated with the ADP; (iii) create, store, and share DACs (discussed below); (iv) input information in order to create and customize profiles (e.g., user, device, social networking, gaming, etc.) associated with a user's account; and (v) view and manipulate information derived from one or more sensors, the one or more PSU, etc. One of ordinary skill in the art will appreciate that the software application may enable operators to perform additional or alternative functionalities without departing from the scope of the invention. In one embodiment of the invention, the software application (402) includes a platform software development kit (SDK) (404) and one or more third-party SDK(s) (406). Each of these components is described below.

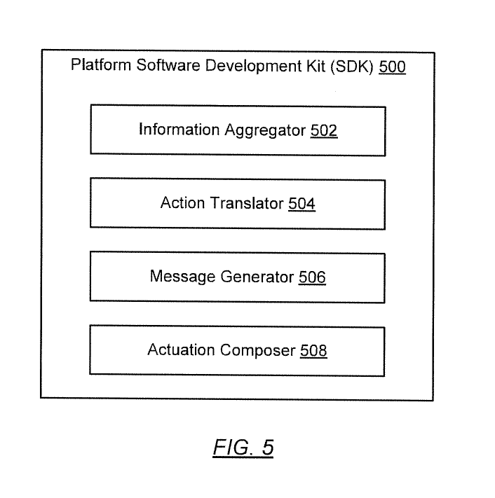

In one embodiment of the invention, the platform SDK (404) refers to hardware, software, firmware, or any combination thereof, which provides the tools for the software application (402) to implement and access the support resources associated with the ADP (not shown) The platform SDK (404) is described in further detail below with respect to FIG. 5.

In one embodiment of the invention, the one or more third-party SDKs (406) refers to hardware, software, firmware, or any combination thereof, which provides tools for the software application (402) to command, retrieve information (e.g., sensor information, state information, user input, etc.), and/or push information (e.g., notifications, updates, PSU output(s), etc.) to a particular adult and/or wearable device. In other words, each adult and/or wearable device may require its own third-party SDK (406), which may be developed by the manufacturer (e.g., third-party provider) of the adult and/or wearable device, for permitting software application developers to integrate the benefits and functionalities of the adult and/or wearable device with their software application product(s).

Returning to the discussion of FIG. 4, the client device (400) includes one or more sensor(s) (408). As discussed above, sensor(s) (408) refers to hardware, software, firmware, or any combination thereof, which detects and measures one or more physical properties (e.g., heat, light, sound, pressure, motion, etc.). Sensor(s) (408) may further include functionality to encode these aforementioned measurements into analog and/or digital signals (or data). Examples of sensor(s) (408) include, but are not limited to, an accelerometer, a GPS device, a pressure sensor, a temperature sensor, a microphone, a camera, a light detector, a photopletismograph (PPG) (i.e., blood flow sensor), an electroencephalograph (EEG) (i.e., bioelectricity sensor), a photoionization detector (PID) (i.e., a gas and/or organic compound sensor), etc.

In one embodiment of the invention, the client device (400) further includes a data repository (410). The data repository (410) may be any type of storage unit, data structure, and/or device (e.g., file system, database, collection of tables, or any other storage mechanism) for storing and/or consolidating information pertinent to embodiments of the invention. In one embodiment of the invention, the information that may be stored/consolidated in the data repository (410) may include, but is not limited to: (i) sensor information from sensor(s) (408) included in one or more adult devices, client devices, and/or wearable devices; (ii) current and/or historical profile information, settings, and/or preferences associated with a user, an adult and/or wearable device, and/or a DAC (discussed below); (iii) any content, data structures, and/or outputs generated and/or utilized by the software application (402); and (iv) any runtime requirements (e.g., libraries, scripts, etc.) needed by the software application (402) to fulfill one or more embodiments of the invention.

In one embodiment of the invention, the communication interface(s) (412) are operatively connected to the software application (402). A communication interface (412) may be hardware, software, firmware, or any combination thereof, which enables and facilitates the exchange of information through a network, and subsequently, to/from other (remote) interfaces. In one embodiment of the invention, the communication interface(s) may include functionality to: (i) receive interaction information (e.g., sensor information, state information, user profile information, device profile information, DAC, etc.) from remote communication interfaces associated with remote entities (e.g., an adult device, a wearable device, the ADP, etc.); and (ii) transmit a variety of information (e.g., sensor information, state information, DSI, user input, etc.) to the aforementioned remote communication interfaces. Examples of the communication interface(s) (412) include, but are not limited to, a computer port, a network interface controller, a network interface device, a network socket, and antennae.

FIG. 5 shows a diagram of a platform software development kit (SDK) in accordance with one or more embodiments of the invention. The platform SDK (500) includes an information aggregator (502), an action translator (504), a message generator (506), and an actuation composer (508). Each of these components is described below.

In one embodiment of the invention, the information aggregator (502) refers to hardware, software, firmware, or any combination thereof, which provides a software application tool for implementing data aggregation. In one embodiment of the invention, the information aggregator (502) may include functionality to: (i) obtain sensor and/or state information from the client device on which the software application is executing, and one or more adult and/or wearable devices that are linked to the client device; and (ii) pre-process the aforementioned collected information as appropriate (discussed below).

In one embodiment of the invention, the action translator (504) refers to hardware, software, firmware, or any combination thereof, which provides a software application tool for deciphering an action (discussed below) originating from the ADP. The action translator (504) may include functionality to: (i) convert/translate master instructions included in an action to DSI that may be interpreted by one or more respective adult and/or wearable devices; and (ii) access and utilize components and/or tools within one or more third-party SDKs towards generating the DSI.

In one embodiment of the invention, the message generator (506) refers to hardware, software, firmware, or any combination thereof, which provides a software application tool for generating a message (discussed below) that may be directed to the ADP, and/or one or more other users or third-party providers via the ADP. The message generator (506) may include functionality to: (i) encapsulate information (e.g., sensor information, state information, resource requests, context instructions, etc.) into any existing (or later developed) encapsulation formats for traversing through a network to reach the ADP; and (ii) apply and remove any existing (or later developed) data compression technique onto the information to be transmitted.

In one embodiment of the invention, the actuation composer (508) refers to hardware, software, firmware, or any combination thereof, which provides a software application tools for generating and/or modifying device actuation compositions (DAC). In one embodiment of the invention, a DAC refers to one or more profiles for driving the actuation of one or more actuators included within one or more adult devices (separately or with overlap) for any specified duration of time. A DAC may additionally, or alternatively, be described as a computer program file or executable that instructs how the one or more adult devices are to operate their one or more actuators during activities involving the one or more adult devices and one or more users. In one embodiment of the invention, a DAC may be created and/or modified by users of the ADP or a third-party provider. Furthermore, a DAC may be produced as a separate product or may accompany and be synchronized to adult multimedia content. For example, a third-party provider may desire to append a DAC to an adult multimedia product in order for users to physically experience the activities presented in the adult multimedia product via their adult and/or wearable devices.

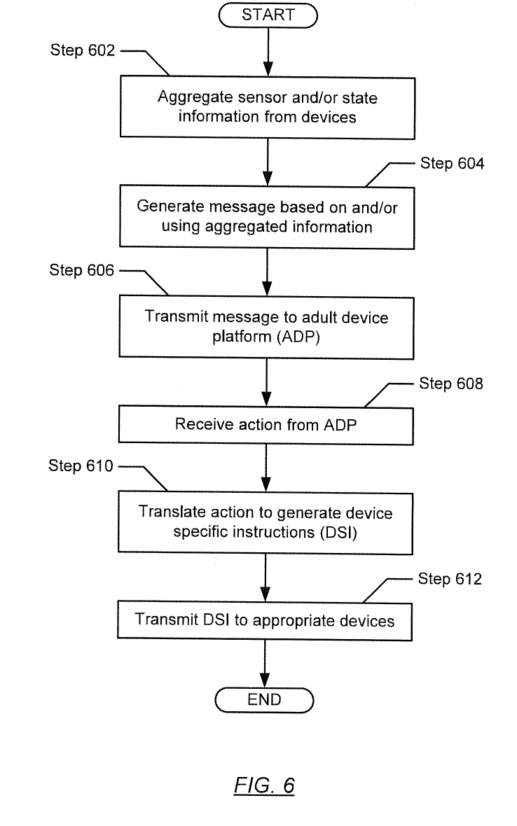

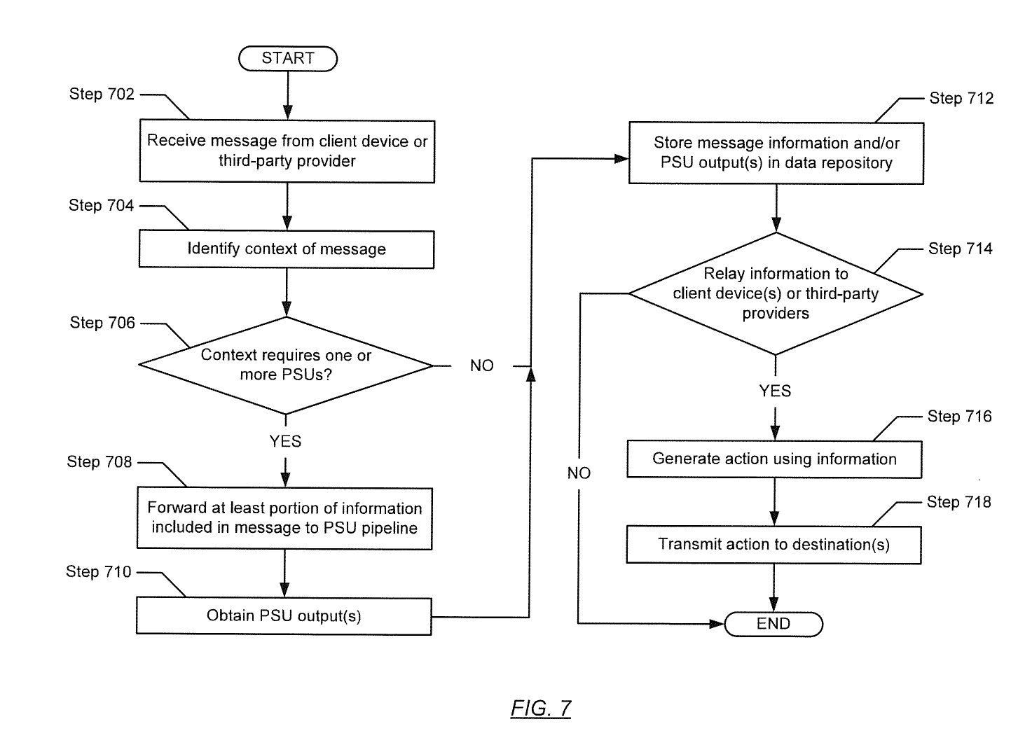

FIG. 6 and FIG. 7 show flowcharts in accordance with one or more embodiments of the invention. While the various steps in these flowcharts are presented and described sequentially, one of ordinary skill will appreciate that some or all of the steps may be executed in different orders, may be combined or omitted, and some or all of the steps may be executed in parallel. In one embodiment of the invention, the steps shown in FIG. 6 and FIG. 7 may be performed in parallel with any other steps shown in FIG. 6 and FIG. 7 without departing from the invention.

FIG. 6 shows a flowchart that describes a method for generating DSI in accordance with one or more embodiments of the invention. In Step 602, sensor and/or state information from one or more devices is aggregated. In one embodiment of the invention, aggregation of the aforementioned information may be realized through a pull mechanism instantiated by the client device. In one or more embodiments of the invention, aggregation of the aforementioned information may be realized through a push mechanism programmed into the one or more adult devices and/or wearable devices operatively connected to the client device. The pull mechanism may be synonymous with data polling or sampling, wherein the client device may submit requests to the one or more adult and/or wearable devices for current sensor and/or state information. In pushing the aforementioned information, an adult and/or wearable device may broadcast current values of sensor and/or state information to the client device constantly, periodically, or in response to changes in the aforementioned information.

In one embodiment of the invention, as discussed above, sensor information refers to sensor data from one or more sensors included in the one or more adult devices and/or wearable devices (linked to the client device and/or operator), which has been collected and/or pre-processed. In one embodiment of the invention, pre-processing entails the performance of preliminary algorithms and/or procedures to prepare the raw data for later analytics and/or manipulations. Pre-processing includes, but is not limited to, cleaning, normalization, transformation, and feature extraction. Data cleaning refers to detecting and correcting inconsistencies (e.g., corruptions, outliers, errors, etc.) within the raw data. Normalization refers to the standardizing of data obtained from different sources (e.g., adult devices, wearable devices, etc.) so as to conform and/or present the different data in a consistent fashion. Transformation refers to converting the data, from an original format and/or type, to a format and/or type that may be compatible or interpretable by a destination system (e.g., the ADP). Feature extraction refers to identifying or isolating data that may be informative and non-redundant, thereby facilitating analytics, learning, and/or other operations that depend on the quality of the data. One of ordinary skill in the art will appreciate that one or more existing and/or later developed paradigms corresponding to the disciplines of, for example, machine learning, data mining, pattern recognition, and image processing may be applied towards implementing feature extraction.

In one embodiment of the invention, state information refers to current and/or historical values pertaining to the one or more features and/or settings associated with the one or more adult devices and/or wearable devices. Examples of state information may include, but are not limited to, the radial expansion of the adult device, the linear expansion of the adult device, the frequency of vibration, the amplitude of vibration, the duration of vibration, the frequency of expansion, and the overlap of vibration amongst the one or more actuators included in the adult device.

In Step 604, a message is generated based on and/or using the information aggregated in Step 602. In one embodiment of the invention, the message may refer to a resources request. In such an embodiment, as discussed above, a resource may include, for example, access to cloud computing logic, data storage, content generation, retrieval, and/or dissemination, software and/or firmware updates, the one or more PSU (see e.g., FIG. 2), and any other service and function supported by the ADP. As such, the message may include the sensor information in order for the sensor information to be fed through one or more of the services, processes, and functions associated with the ADP. Further to the resources request embodiment, the message may include, in addition to or in place of the sensor information, instructions, content, etc., that may be pertinent to activities involving at least the operator of the client device and one or more other (remote) users of the ADP. In another embodiment of the invention, the generated message may reflect the implementation of an information synchronization mechanism between the ADP and the various devices associated with a particular user. That is, in such an embodiment, the message may include the aforementioned state information, alongside instructions that direct the ADP to store, consolidate, and/or share the state information with other devices and/or third-party providers operatively connected to the ADP.

In Step 606, the message(s) generated in Step 604 is/are transmitted to the ADP. In one embodiment of the invention, transmission of the message(s) may traverse or employ any existing (or later developed) wired and/or wireless communications framework and protocol, or any combination thereof.

In Step 608, an action is received from the ADP. In one embodiment of the invention, the action may or may not result from an earlier transmission of a message towards the ADP. Further, in one embodiment of the invention, an action may refer to master instructions and/or content (e.g., multimedia, analytics, trends, results, DAC, etc.). Subsequently, these instructions and/or content may be executed and/or implemented on a client device, one or more adult devices, and one or more wearable devices towards maintaining user engagement in activities involving adult devices. Actions are further described below with respect to FIG. 7.

In Step 610, the action (received in Step 608) is translated, thereby generating one or more DSI. As mentioned above, in one embodiment of the invention, an action includes master instructions. These master instructions may be intended for interpretability by an ADP client (e.g., software application (see, e.g., FIG. 4)) executing on a client device. In one embodiment of the invention, the action translator (discussed above), in conjunction with one or more third-party SDKs, converts portions of the master instructions to DSI, which are interpretable by the adult and/or wearable device associated with a third-party SDK. As discussed above, a third-party SDK may include resources (e.g., tools, utilities, libraries, etc.) which allow any external hardware, software, firmware, or any combination thereof (e.g., the software application) to command (and/or acquire information from) a respective adult device and/or wearable device.

In Step 612, the one or more DSI generated in Step 610 are transmitted towards the one or more adult devices and/or wearable devices linked to/controlled by the client device. Additionally, in one embodiment of the invention, at least a subset of the content included in the action (of Step 610) may be disseminated to respective adult and/or wearable devices alongside the DSI.

FIG. 7 shows a flowchart that describes a method for generating an action in accordance with one or more embodiments of the invention. In Step 702, a message is received from a client device or a third-party provider. In one embodiment of the invention, the message includes information that may need to be stored/consolidated in the ADP, relayed to other client devices or third-party providers, and/or be fed through a PSU for processing in accordance with their respective functionalities (discussed above). Information included within a message may include, but is not limited to: (i) sensor and/or state information associated with one or more sensors included in one or more client devices, adult devices, and/or wearable devices; (ii) user input towards the enablement of features provided by the ADP or towards population of the various profiles (e.g., user, device, social networking, etc.) utilized and maintained by the ADP; (iii) content (e.g., multimedia, DACs, etc.) developed/provided by users and third-party providers; and (iv) context instructions or data, which specify the context associated with the message (discussed below).

In Step 704, the received message is examined in order to identify the context associated with the message. In one embodiment of the invention, the context of a message refers to instructions and/or data that specifies its purpose or how the information included in the message is to be handled. For example, as discussed above, information in a message may want to be consolidated in the ADP, or be relayed to another component system (see, e.g., FIG. 1), or be processed in lieu of any and/or all of the services, processes, and/or functions provided by the ADP. In one embodiment of the invention, the context of the message may also include user, device, etc., identifiers for facilitating the transmitting of information towards other system components or users, if necessary.

In Step 706, a first determination is made as to whether the context of the message requires that the included information be processed by one or more PSU (see, e.g., FIG. 2). If it is determined that the context includes instructions/data for PSU processing, the process proceeds to Step 708; otherwise, the process proceeds to Step 712.

In Step 708, upon determining that the context of the message requires PSU processing, at least a portion of the information included in the message is forwarded through the PSU pipeline. In one embodiment of the invention, the information that may traverse the pipeline may include, but is not limited to, sensor information, state information, profile information, and content. Processing of the aforementioned information is conducted in accordance with the respective functionalities of the PSU as discussed above (see, e.g., FIG. 2).

In Step 710, output(s) from the one or more PSU, yielded by their separate and/or combined efforts, is/are obtained. In one embodiment of the invention, the output(s) are molded based on the respective functionalities of the one or more PSU. For example, the output of the learning intelligence (see, e.g., 206A in FIG. 2) includes, but is not limited to, mappings or associations between sensor information, profile information, state information, etc.

In Step 712, the obtained PSU output(s) and/or information included in the message are stored in the ADP data repository. In one embodiment of the invention, the PSU output(s) and/or information may be organized in the data repository with respect to users, devices, activities, trends, or any other theme for organizing information.

In Step 714, a second determination is made as to whether the PSU output(s) and/or information included in the message is designated for deliverance to one or more other client devices and/or third-party providers. If it is determined that the aforementioned information needs to be relayed, then the process proceeds to Step 716; otherwise, the process ends.

In Step 716, upon determining that the PSU output(s), sensor information, state information, profile information, and/or content needs to be delivered to other destinations (e.g., client devices and third-party providers), an action is generated encompassing the necessary information. In one embodiment of the invention, as discussed above, an action refers to master instructions and/or content (e.g., multimedia, analytics, trends, results, DAC, etc.). Subsequently, these instructions and/or content may be executed and/or implemented on a client device, one or more adult devices, and one or more wearable devices towards maintaining user engagement in activities involving adult devices. Additionally, or alternatively, an action may forward the aforementioned content towards third-party providers in aiding third-party providers to improve their products, services, and/or content to users. In one embodiment of the invention, generation of an action may involve the application of any existing (or later developed) data compression and encapsulation techniques.

In Step 718, the generated action(s) is transmitted towards their respective destinations (e.g., client devices or third-party providers). In one embodiment of the invention, transmission of the action(s) may traverse or employ any existing (or later developed) wired and/or wireless communications framework and protocol, or any combination thereof.

Embodiments of the invention may be implemented on a computing system. Any combination of mobile, desktop, server, router, switch, embedded device, or other types of hardware may be used. For example, as shown in FIG. 8.1, the computing system (800) may include one or more computer processors (802), non-persistent storage (804) (e.g., volatile memory, such as random access memory (RAM), cache memory), persistent storage (806) (e.g., a hard disk, an optical drive such as a compact disk (CD) drive or digital versatile disk (DVD) drive, a flash memory, etc.), a communication interface (812) (e.g., Bluetooth interface, infrared interface, network interface, optical interface, etc.), and numerous other elements and functionalities.

The computer processor(s) (802) may be an integrated circuit for processing instructions. For example, the computer processor(s) may be one or more cores or micro-cores of a processor. The computing system (800) may also include one or more input devices (810), such as a touchscreen, keyboard, mouse, microphone, touchpad, electronic pen, or any other type of input device.

The communication interface (812) may include an integrated circuit for connecting the computing system (800) to a network (not shown) (e.g., a local area network (LAN), a wide area network (WAN) such as the Internet, mobile network, or any other type of network) and/or to another device, such as another computing device.

Further, the computing system (800) may include one or more output devices (808), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (802), non-persistent storage (804), and persistent storage (806). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (800) in FIG. 8.1 may be connected to or be a part of a network. For example, as shown in FIG. 8.2, the network (820) may include multiple nodes (e.g., node X (822), node Y (824)). Each node may correspond to a computing system, such as the computing system shown in FIG. 8.1, or a group of nodes combined may correspond to the computing system shown in FIG. 8.1. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (800) may be located at a remote location and connected to the other elements over a network.

Although not shown in FIG. 8.2, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (822), node Y (824)) in the network (820) may be configured to provide services for a client device (826). For example, the nodes may be part of a cloud computing system. The nodes may include functionality to receive requests from the client device (826) and transmit responses to the client device (826). The client device (826) may be a computing system, such as the computing system shown in FIG. 8.1. Further, the client device (826) may include and/or perform all or a portion of one or more embodiments of the invention.

The computing system or group of computing systems described in FIGS. 8.1 and 8.2 may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the GUI by a user selecting one or more GUI widgets or inserting text and other data into GUI widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system in FIG. 8.1. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail—such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 8.1, while performing one or more embodiments of the invention, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the invention, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 8.1 may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 8.1 may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 8.1 and the nodes and/or client device in FIG. 8.2. Other functions may be performed using one or more embodiments of the invention.

The following example is for explanatory purposes only and not intended to limit the scope of the invention.

FIG. 9 shows a data flow diagram of an example in accordance with one or more embodiments of the invention. More specifically, FIG. 9 shows a system (900), which includes the adult device platform (ADP) (902), an adult content provider S (904), and various client, adult, and wearable devices (906, 908, 910, 912, 914, 916, 918, 920, 922). These components are further operatively connected to one another via a network (924).

By way of a first scenario, consider the ADP (902) is providing engagement to a first user (e.g., User A). The first user is operating, and is operatively connected to the ADP using, a client device (e.g., User A Client Device (906)). Linked to the client device associated with the first user (and the various profiles maintained by the ADP pertaining to the user) are two adult devices (e.g., User A Adult Device X (912) and User A Adult Device Y (914)) and a wearable device (e.g., User A Wearable Device J (916)). For clarification purposes pertaining to the example, consider adult device X to be one type of vibrator manufactured by a first third-party provider, and adult device Y to be another type of vibrator manufactured by a second third-party provider. Further, wearable device J may be a smart watch produced by a third third-party provider.

In this first scenario, while operatively connected to the ADP (902), the first user is partaking in solo sexual or exercising activities. During these activities, sensor and/or state information associated with adult device X (912), adult device Y (914), and wearable device J (916) are periodically being uploaded to the first user client device (906). This information is then relayed to the ADP (902) using one or more messages. In one embodiment of the invention, the sensor and/or state information, describing the usage, preferences, and biometrics associated with the first user's activities, are provided to at least the learning intelligence. In one embodiment of the invention, other information, such as one or more of the various profile information (e.g., user, device, social networking, etc.) elements may be additionally fed to the learning intelligence. In turn, the learning intelligence applies one or more predetermined algorithms towards determining informative mappings/connections associating characteristics pertaining to adult device X and Y, user orientation, preferences, etc.

These informative mappings/connections may be transmitted back to the first user's client device (906) alongside a custom DAC based on the informative mappings in an action. From here, the first user's client device (906) obtains the action and translates it, thereby generating device specific instructions (DSI). The generated DSI may also incorporate the instructions/data provided by the custom DAC, which may be implemented/executed by the adult devices (912, 914) towards aiding the first user to fulfill their sexual and/or exercising objectives (e.g., quicker route to orgasm, targeted muscle use, etc.).

By way of a second scenario, the ADP (902) may be providing engagement to the first user and a second user (e.g., User B), who may be partaking in a joint activity involving their respective adult devices. In one embodiment of the invention, the users may be co-located and/or physically proximal to one another. In another embodiment of the invention, the users may be located at different sites, however, yet operatively connected to one another via the network (924). With regard to this second scenario, the second user may be operating, and is operatively connected to the ADP (902) using, a second client device (e.g., User B Client Device (908)). Furthermore, linked to the second client device are a third adult device (e.g., User B Adult Device X (918)) and a second wearable device (e.g., User B Wearable Device L (920)). Per consistency of the example, the second user's adult device X (918) is an adult device of a similar model to the first user's adult device X (912), which is manufactured by a first adult device manufacturer. The second user's wearable device (920) may, for example, be representative of a smart shirt worn by the second user.

In this second scenario, in one embodiment of the invention, the second user may be interacting with their respective adult device (918) in order to generate a custom device actuation composition (DAC) (discussed above). The DAC utilizes sensor and/or state information deriving from the second user's adult device (918) and wearable device (920), as well as tools provided by third-party software development kits (SDKs), to capture instructions/data that may be interpreted by other adult device X (e.g., User A Adult Device X (912)) models. The second user may then upload their custom DAC to the ADP (902), which may be marked as shareable content that may be accessible to other users of the ADP, for example, the first user. In another embodiment of the invention, the ADP (902) provides support resources for enabling the second user to remotely control the one or more adult devices (912, 914) linked to the client device (906) of the first user in real or near-real time.

By way of a third scenario, the ADP (902) may be providing engagement to multiple users (e.g., User A and User B) involving a service and/or content from a third party provider (e.g., Adult Content Provider S (904)). In such a scenario, a DAC developer (e.g., Developer D) harnesses the SDKs incorporated in the software application executing on their client device (910) to create a DAC. Further, the developer's client device is linked to a fourth adult device (e.g., Developer D Adult Device X′ (922)). In one embodiment of the invention, the fourth adult device may complement another adult device X (912, 918) (e.g., produce actuations that emulate the actuations produced by adult device X). For example, as mentioned above, adult device X may refer to a first type of vibrator. As such, the adult device X′ may conform to a penetrative and/or vibratory device or mechanism (e.g., a dildo), which sources the stimuli provided by the vibrator and experienced by users utilizing that specific vibrator type. In one embodiment of the invention, the generated DAC may or may not be appended to (or synched with) content (e.g., a multimedia file or service) offered by adult content provider S (904). The DAC and/or content may be shared with other users (e.g., User A, User B), via a marketplace supported by the ADP.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A system, comprising:
a data repository; and
a platform kernel communicatively connected to the data repository, the platform kernel configured to execute instructions on a computer processor to perform:
receiving a message from a client device, the message comprising a plurality of interaction information,
examining the message to identify a context,
determining whether the context requires at least one platform specific utility (PSU),
sending the plurality of interaction information to the at least one PSU, and
obtaining output from the at least one PSU in the form of a plurality of connections between the plurality of interaction information and an adult device.

2. The system of claim 1, wherein the plurality of connections assists in learning to enhance interaction between a user and the adult device.

3. The system of claim 1, wherein the plurality of connections assist in predicting behavior to enhance interaction between a user and the adult device.

4. The system of claim 1, further comprising an adult device platform (ADP), wherein the ADP comprises the PSU, the platform kernel, and the data repository.

5. The system of claim 4, further comprising:
a wearable device configured to provide the plurality of interaction information;
a third-party provider configured to provide content for a plurality of users,
wherein the adult device is configured to:
receive a plurality of input data from a sensor and configured to execute instructions to:
pre-process the plurality of input data in a format accepted by a client device to obtain processed data,
send the processed data to the client device, and
receive, from the client device, device specific instructions (DSI) to modify operations of the adult device,
wherein the client device is configured to:
obtain the plurality of input data from at least one of a group consisting of the adult device and the wearable device, and
transmit the plurality of input data to the ADP, and
wherein the ADP, the adult device, the client device, the wearable device, and the third-party provider are communicatively connected via a network.

6. The system of claim 1, wherein the PSU comprises:
a learning intelligence configured to perform analytics, adaptive learning, and predictive modeling,
an experience advisor configured to provide recommendations to a user,
a game manager configured to support gamification of the adult device,
a product advertiser configured to supply content from third-party providers to the user,
a social networker configured to provide social connectivity between a plurality of users, and
a content broker configured to provide a marketplace to the plurality of users.

7. An adult device, comprising:
a sensor configured to obtain a plurality of input data;
a computer processor receiving the plurality of input data from the sensor and configured to execute instructions to:
pre-process the plurality of input data in a format accepted by a client device to obtain processed data,
send the processed data to the client device, and
receive, from the client device, device specific instructions (DSI) to modify operations of the adult device; and
a power source configured to provide power to the computer processor and the sensor.

8. The adult device of claim 7 further comprising:
an actuator configured to provide stimulation to a user.

9. The adult device of claim 7 further comprising:
a communication interface configured to provide data to the client device.

10. The adult device of claim 9, wherein the communication interface is further configured to enable the adult device to connect to a network employing any wired, wireless, or a wired-wireless combination of communication protocol.

11. The adult device of claim 7, wherein the DSI to modify the operations of the adult device are generated based on the plurality of input data used for adaptive learning about interaction between a user and the adult device.

12. The adult device of claim 7, wherein the DSI to modify the operations of the adult device are generated based on the plurality of input data used for predicting behavior about interaction between a user and the adult device.

13. A method for enhancing interactions with an adult device, comprising:
receiving a message from a client device, the message comprising interaction information;
examining the message to identify a context;
determining whether the context requires at least one platform specific utility (PSU);
sending the interaction information to the at least one PSU; and
obtaining output from the at least one PSU in the form of a plurality of connections between the interaction information and the adult device.

14. The method of claim 13, further comprising:
storing the interaction information and the output in a data repository.

15. The method of claim 14, further comprising:
determining whether to relay the interaction information or the output to at least one destination;
generating an action using the interaction information; and
transmitting the action towards the at least one destination.

16. The method of claim 15, wherein the at least one destination comprises at least one client device.

17. The method of claim 15, wherein the at least one destination comprises at least one third-party provider.

18. The method of claim 13, wherein the interaction information comprises sensor information from a plurality of sensors included in the client device, an adult device, or a wearable device.

19. The method of claim 18, wherein the sensor information comprises orientation information in reference to a user.

20. The method of claim 18, wherein the sensor information comprises biometric information associated with a user.

21. The method of claim 18, wherein the sensor information comprises environmental information describing an environment proximal to a user.

22. The method of claim 13, wherein the interaction information further comprises state information from the adult device, wherein the state information describes current settings associated with the adult device.

23. The method of claim 13, wherein the context comprises instructions on how to handle the interaction information.

24. The method of claim 13, wherein the at least one PSU comprises a learning intelligence, an experience advisor, a game manager, a product advertiser, a social networker, or a content broker.

25. A method for controlling an adult device, comprising:
receiving an action from an adult device platform (ADP);
processing the action to obtain device specific instructions (DSI);
identifying, based on the action, the adult device to which the DSI is designated; and
transmitting the DSI to modify operations of the adult device.

26. The method of claim 25, further comprising:
obtaining the DSI using a software development kit (SDK) associated with the adult device, wherein the SDK comprises a listing of commands specific to operating the adult device.

27. The method of claim 25, further comprising:
obtaining the DSI using an application programming interface (API) associated with the adult device, wherein the API comprises a listing of commands specific to operating the adult device.

28. The method of claim 25, wherein the action comprises master instructions describing a procedure to obtain the DSI.

29. The method of claim 25, wherein the DSI comprises instructions directing the adult device to enable, disable, or adjust a setting associated with the adult device.

30. The method of claim 29, wherein the DSI further comprises a device actuation composition (DAC), wherein the DAC drives at least one actuator included in the adult device.
